(19) United States
(12) Patent Application Publication
(10) Pub. No.: US 2015/0098208 A1
(43) Pub. Date: Apr. 9, 2015

(54) PANEL LIGHT MODULE AND BACKLIGHT MODULE

(71) Applicant: LEXTAR ELECTRONICS CORPORATION, HSINCHU (TW)

(72) Inventors: Chen-Yi SU, Taoyuan County (TW); Yung-Long JIAN, New Taipei City (TW)

(73) Assignee: LEXTAR ELECTRONICS CORPORATION, HSINCHU (TW)

(21) Appl. No.: 14/292,641

(22) Filed: May 30, 2014

(30) Foreign Application Priority Data
Oct. 9, 2013 (TW) 102136462

(51) Int. Cl. G02B 5/02; F21V 17/10

(52) U.S. Cl. CPC G02B 5/021; F21V 17/10
USPC 362/97.1

(57) ABSTRACT

A backlight module is provided, including a bottom plate, a light source, an edge frame, a diffusing sheet, a diffusing plate and a front frame. The light source is disposed on the bottom plate. The edge frame surrounds the light source and abuts the bottom plate to form a groove. The diffusing sheet includes a front side and a back side, wherein the front side is opposite the back side, and the diffusing sheet is disposed in a light-emitting direction of the light source. The diffusing plate is disposed on the front side of the diffusing sheet. The front frame includes a light-emitting opening, wherein a position groove is formed between the front frame and the edge frame, and the diffusing plate and the diffusing sheet are tightly clipped in the positioning groove.

### CROSS REFERENCE TO RELATED APPLICATIONS

This Application claims priority of Taiwan Patent Application No. 102136462, filed on Oct. 9, 2013, the entirety of which is incorporated by reference herein.

### BACKGROUND OF THE INVENTION

1. Field of the Invention

The present invention relates to a panel light module and a backlight module, and in particular to a panel light module and a backlight module with a properly fastened diffusing sheet.

2. Description of the Related Art

In a conventional panel light module (or backlight module), a diffusing sheet overlaps a diffusing plate, and is located, relative to the diffusing plate, at an outer side of the backlight module/panel light module (in other words, the diffusing plate is located between the diffusing sheet and the light source). The diffusing sheet is commonly made of soft material. The assembled diffusing sheet would be curved downward due to gravity, and cannot sufficiently contact the diffusing plate. Particularly, in direct type panel light modules, the downwardly curved diffusing sheet affects the appearance of the panel light module, and deteriorates the uniformity of the light provided thereby. Additionally, an additional mechanism for fastening the diffusing sheet is required, which increases the cost of the whole panel light module (or backlight module), and causes the panel light module (or backlight module) to be more difficult to assemble.

### BRIEF SUMMARY OF THE INVENTION

A backlight module and a panel light module are provided. The backlight module (or the panel light module) includes a bottom plate, a light source, an edge frame, a diffusing sheet, a diffusing plate and a front frame. The light source is disposed on the bottom plate, wherein a light-emitting surface of the light source is on a side of the light source back to the bottom plate. The edge frame surrounds the light source and abuts the bottom plate to form a groove, wherein a stair-shaped supporting portion is formed in the groove on an edge of the edge frame. The diffusing sheet includes a front side and a back side, wherein the front side is opposite the back side, an edge of the back side is supported by the stair-shaped supporting portion, and the diffusing sheet is disposed in a light-emitting direction of the light source. The diffusing plate is disposed on the front side of the diffusing sheet, wherein an edge of the diffusing plate partially overlaps the stair-shaped supporting portion. The front frame includes a light-emitting opening, wherein the front frame is fastened to the edge frame, a position groove is formed between the front frame and the stair-shaped supporting portion, the diffusing plate abuts an edge of the front frame, and the diffusing plate and the diffusing sheet are tightly clipped in the positioning groove.

Utilizing the backlight module and the panel light module of the embodiment of the invention, the diffusing plate overlaps the diffusing sheet, and is located, relative to the diffusing sheet, at an outer side of the backlight module/panel light module (in other words, the diffusing sheet is located between the diffusing plate and the light sources). The thickness and hardness of the diffusing plate are greater than that of the diffusing sheet, and it is difficult to bend. Therefore, by disposing the diffusing plate at the outer side of the backlight module/panel light module, the problem of the diffusing sheet being curved by gravity is solved, and the assembly process of the backlight module/panel light module is also simplified.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows the panel light module (backlight module) of the first embodiment of the invention;

FIG. 2 shows the inner structure of the diffusing sheet;

FIG. 3 shows the inner structure of the diffusing plate; and

FIG. 4 shows the panel light module (backlight module) of the second embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

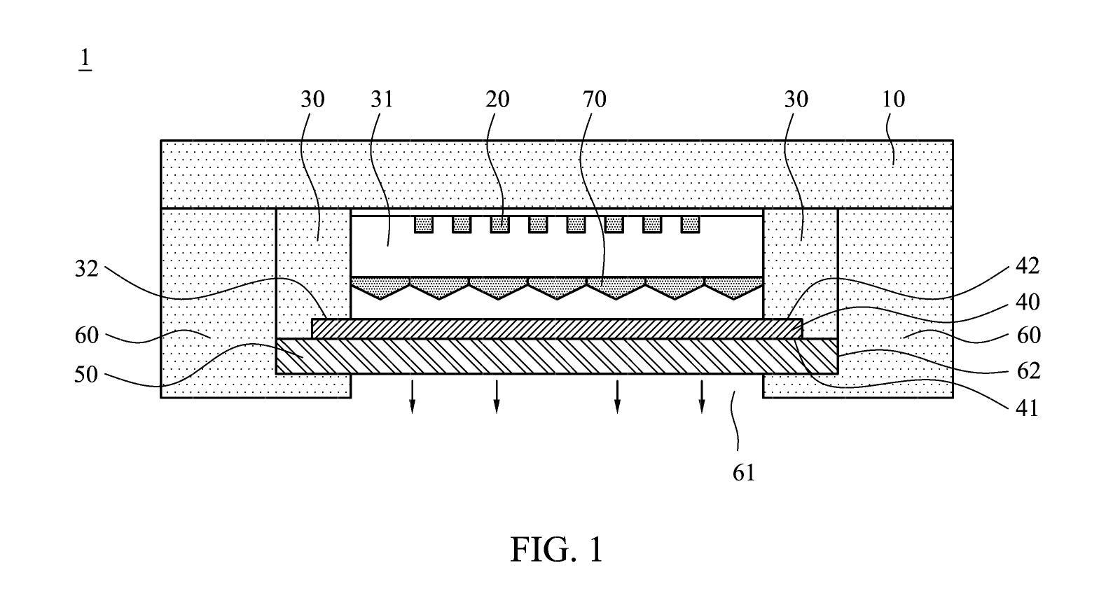

FIG. 1 shows a panel light module (backlight module) 1 of a first embodiment of the invention (direct type panel light module), comprising a bottom plate 10, a plurality of light sources 20, an edge frame 30, a diffusing sheet 40, a diffusing plate 50 and a front frame 60. The light sources 20 are disposed on the bottom plate 10, wherein a light-emitting surface of each light source 20 is on a side of the light source 20 back to the bottom plate 10. The edge frame 30 surrounds the light sources 20 and abuts the bottom plate 10 to form a groove 31, wherein a stair-shaped supporting portion 32 is formed in the groove 31 on an edge of the edge frame 30. The diffusing sheet 40 comprises a front side 41 and a back side 42, wherein the front side 41 is opposite the back side 42, an edge of the back side 42 is supported by the stair-shaped supporting portion 32, and the diffusing sheet 40 is disposed in a light-emitting direction of the light source 20. The diffusing plate 50 is disposed on the front side 41 of the diffusing sheet 40, wherein an edge of the diffusing plate 50 partially overlaps the stair-shaped supporting portion 32. The front frame 60 comprises a light-emitting opening 61, wherein the front frame 60 is fastened to the edge frame 30, a position groove 62 is formed between the front frame 60 and the stair-shaped supporting portion 32, the diffusing plate 50 abuts an edge of the front frame 60, and the diffusing plate 50 and the diffusing sheet 40 are tightly clipped in the positioning groove 62.

In one embodiment, a thickness of the diffusing sheet 40 is between 0.5 and 1 mm, and a thickness of the diffusing plate 50 is between 1.5 and 10 mm.

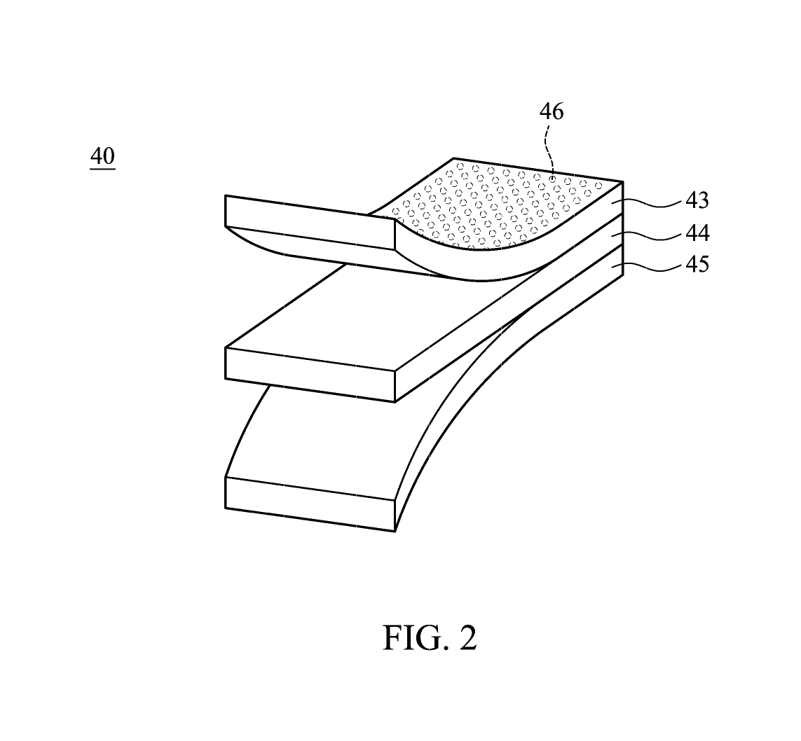

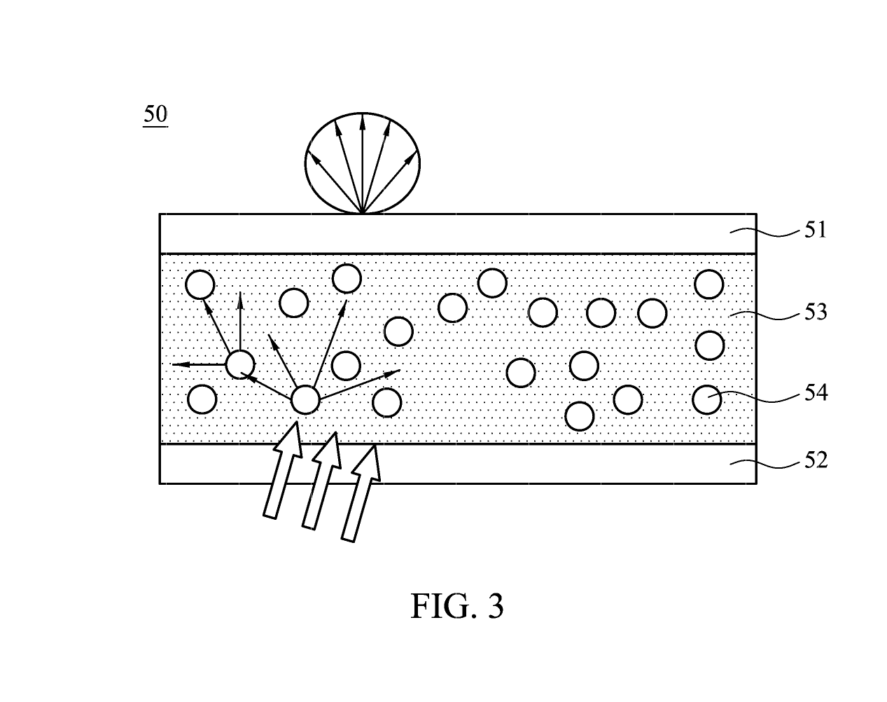

With reference to FIGS. 2 and 3, FIG. 2 shows an inner structure of the diffusing sheet 40, and FIG. 3 shows an inner structure of the diffusing plate 50. The diffusing sheet 40 comprises a diffusing sheet particle layer 43, an optical film layer 44 and a static electricity resistant layer 45. The diffusing sheet particle layer 43 comprises a plurality of first diffusing particles 46. The diffusing plate 50 comprises a first ultraviolet ray resistant layer 51, a second ultraviolet ray resistant layer 52 and a diffusing plate particle layer 53. The diffusing plate particle layer 53 comprises a plurality of second diffusing particles 54.

In one embodiment, the density d1 of the first diffusing particles 46 inside the diffusing sheet 40 is greater than the density d2 of the second diffusing particles 54 inside the diffusing plate 50. In one embodiment, the diameter D1 of the first diffusing particles 46 is smaller than the diameter D2 of the second diffusing particles 54, wherein the diameter D1 of the first diffusing particles 46 is substantially between 1 and 50 μm, and the diameter D2 of the second diffusing particles 54 is substantially between 1 and 100 μm.

With reference to FIG. 1, the front frame 60 can be fastened to the edge frame 30 via adhering, embedding, wedging, screw, welding or telescoping.

With reference to FIG. 1, in one embodiment, the panel light module 1 can further comprise a brightness enhancement film 70, corresponding to the back side 42 of the diffusing sheet 40.

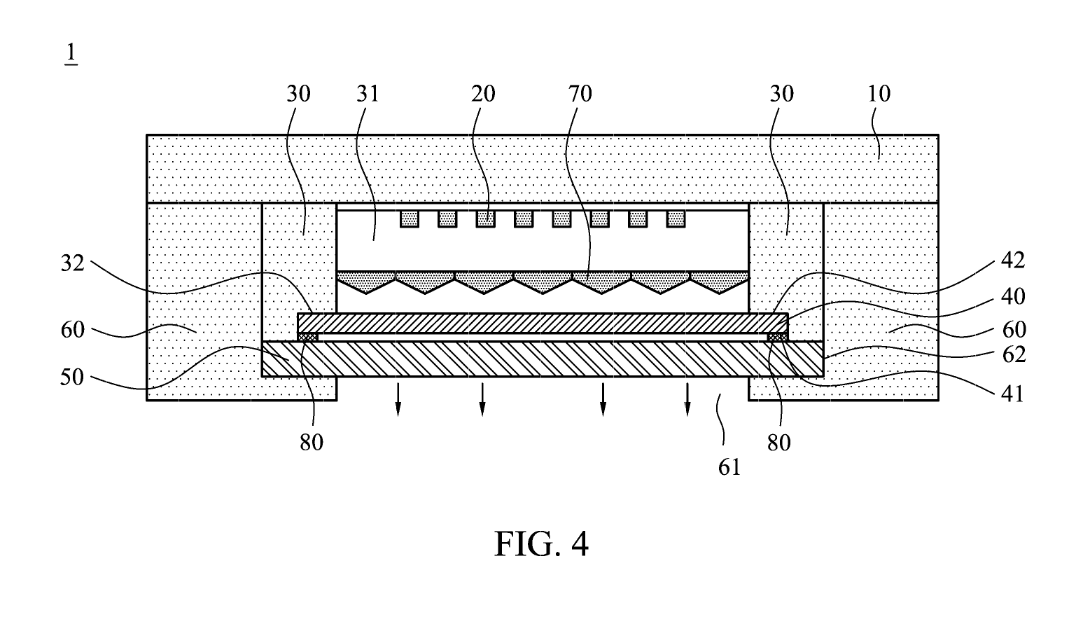

As shown in FIG. 1, in one embodiment, the diffusing plate 50 and the diffusing sheet 40 are tightly clipped in the positioning groove 62 to be fastened by mechanical means. With reference to FIG. 4, in a second embodiment of the invention, the diffusing sheet 40 is adhered to a back side of the diffusing plate 50. For example, the diffusing sheet 40 is adhered to the back side of the diffusing plate 50 via twin adhesive tape 80 to further fasten the diffusing plate 50 and the diffusing sheet 40.

In the embodiment above, the direct type panel light module and backlight module are provided as an example. However, the invention is not limited thereto. The invention can also be utilized in the panel light module (or backlight module) of side-edge type or other types.

The backlight module of the embodiment of the invention can be utilized in displays or portable electronic devices to provide backlighting. The panel light module of the embodiment of the invention can be utilized in panel lamps to provide illumination.

Utilizing the backlight module and the panel light module of the embodiment of the invention, the diffusing plate overlaps the diffusing sheet, and is located, relative to the diffusing sheet, at an outer side of the backlight module/panel light module (in other words, the diffusing sheet is located between the diffusing plate and the light sources). The thickness and hardness of the diffusing plate are greater than that of the diffusing sheet, and it is hard to bend. Therefore, by disposing the diffusing plate at the outer side of the backlight module/panel light module, the problem of the diffusing sheet being curved by gravity is solved, and the assembly process of the backlight module/panel light module is also simplified.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backlight module, comprising:
a bottom plate;
a light source, disposed on the bottom plate, wherein a light-emitting surface of the light source is on a side of the light source back to the bottom plate;
an edge frame, surrounding the light source and abutting the bottom plate to form a groove, wherein a stair-shaped supporting portion is formed in the groove on an edge of the edge frame;
a diffusing sheet, comprising a front side and a back side, wherein the front side is opposite the back side, an edge of the back side is supported by the stair-shaped supporting portion, and the diffusing sheet is disposed in a light-emitting direction of the light source;
a diffusing plate, disposed on the front side of the diffusing sheet, wherein an edge of the diffusing plate partially overlaps the stair-shaped supporting portion; and
a front frame, comprising a light-emitting opening, wherein the front frame is fastened to the edge frame, a position groove is formed between the front frame and the stair-shaped supporting portion, the diffusing plate abuts an edge of the front frame, and the diffusing plate and the diffusing sheet are tightly clipped in the positioning groove.

2. The backlight module as claimed in claim 1, wherein a thickness of the diffusing sheet is between 0.5 and 1 mm, and a thickness of the diffusing plate is between 1.5 and 10 mm.

3. The backlight module as claimed in claim 2, wherein the diffusing sheet comprises a plurality of first diffusing particles, and the diffusing plate comprises a plurality of second diffusing particles.

4. The backlight module as claimed in claim 3, wherein a density d1 of the first diffusing particles inside the diffusing sheet is greater than a density d2 of the second diffusing particles inside the diffusing plate.

5. The backlight module as claimed in claim 4, wherein a diameter D1 of the first diffusing particles is smaller than a diameter D2 of the second diffusing particles.

6. The backlight module as claimed in claim 5, wherein the diameter D1 of the first diffusing particles is substantially between 1 and 50 μm, and the diameter D2 of the second diffusing particles is substantially between 1 and 100 μm.

7. The backlight module as claimed in claim 1, wherein the front frame is fastened to the edge frame via adhering, embedding, wedging, screw, welding or telescoping.

8. The backlight module as claimed in claim 7, further comprising a brightness enhancement film, corresponding to the back side of the diffusing sheet.

9. The backlight module as claimed in claim 8, wherein the diffusing sheet is adhered to a back side of the diffusing plate.

10. The backlight module as claimed in claim 9, wherein the diffusing sheet is adhered to the back side of the diffusing plate via twin adhesive tape.

11. A panel light module, comprising:
a bottom plate;
a light source, disposed on the bottom plate, wherein a light-emitting surface of the light source is on a side of the light source back to the bottom plate;
an edge frame, surrounding the light source and abutting the bottom plate to form a groove, wherein a stair-shaped supporting portion is formed in the groove on an edge of the edge frame;
a diffusing sheet, comprising a front side and a back side, wherein the front side is opposite the back side, an edge of the back side is supported by the stair-shaped supporting portion, and the diffusing sheet is disposed in a light-emitting direction of the light source;
a diffusing plate, disposed on the front side of the diffusing sheet, wherein an edge of the diffusing plate partially overlaps the stair-shaped supporting portion; and
a front frame, comprising a light-emitting opening, wherein the front frame is fastened to the edge frame, a position groove is formed between the front frame and the stair-shaped supporting portion, the diffusing plate abuts an edge of the front frame, and the diffusing plate and the diffusing sheet are tightly clipped in the positioning groove.

12. The panel light module as claimed in claim 11, wherein a thickness of the diffusing sheet is between 0.5 and 1 mm, and a thickness of the diffusing plate is between 1.5 and 10 mm.

13. The panel light module as claimed in claim 12, wherein the diffusing sheet comprises a plurality of first diffusing particles, and the diffusing plate comprises a plurality of second diffusing particles.

14. The panel light module as claimed in claim 13, wherein a density dl of the first diffusing particles inside the diffusing sheet is greater than a density d2 of the second diffusing particles inside the diffusing plate.

15. The panel light module as claimed in claim 14, wherein a diameter D1 of the first diffusing particles is smaller than a diameter D2 of the second diffusing particles.

16. The panel light module as claimed in claim 15, wherein the diameter D1 of the first diffusing particles is substantially between 1 and 50 μm, and the diameter D2 of the second diffusing particles is substantially between 1 and 100 μm.

17. The panel light module as claimed in claim 11, wherein the front frame is fastened to the edge frame via adhering, embedding, wedging, screw, welding or telescoping.

18. The panel light module as claimed in claim 17, further comprising a brightness enhancement film, corresponding to a back side of the diffusing sheet.

19. The panel light module as claimed in claim 18, wherein the diffusing sheet is adhered to a back side of the diffusing plate.

20. The panel light module as claimed in claim 19, wherein the diffusing sheet is adhered to the back side of the diffusing plate via twin adhesive tape.
